(19) United States
(12) Patent Application Publication
(10) Pub. No.: US 2018/0123911 A1
(43) Pub. Date: May 3, 2018

(54) VERIFY SERVICE LEVEL AGREEMENT COMPLIANCE OF NETWORK FUNCTION CHAINS BASED ON A STATEFUL FORWARDING GRAPH

(71) Applicant: Hewlett Packard Enterprise Development LP, Houston, TX (US)

(72) Inventors: Ying Zhang, Palo Alto, CA (US); Sujata Banerjee, Palo Alto, CA (US); Sharon Barkai, Sunnyvale, CA (US)

(21) Appl. No.: 15/336,495

(22) Filed: Oct. 27, 2016

(51) Int. Cl. H04L 12/24; H04L 12/26; H04L 12/733

(52) U.S. Cl. CPC H04L 41/5019; H04L 45/122; H04L 43/0876

(57) ABSTRACT

In some examples, a method includes parsing, by a network device, a set of flow rules and network function configurations to identify an equivalent class of packets passing through network function chains; identifying, by the network device, a plurality of paths that packets belonging to the equivalent class pass through; computing, by the network device, a first set of Service Level Agreement (SLA) performance metrics for the equivalent class; constructing, by the network device, a set of stateful forwarding criteria comprising the first set of SLA performance metrics; and verifying, by the network device, whether the network function chains comply with a SLA based on the stateful forwarding criteria.

### BACKGROUND

Service level agreement (SLA) verification generally focuses on the reachability property verification. For example, a network verification tool may answer a query, such as, “Can network node A communicate with network node B?” Therefore, existing network verification tools focus on checking the connectivity properties of the network, such as reachability, isolation, and loops. However, while connectivity may be a basic guarantee that a network should provide, performance guarantees, such as latency, throughput, bandwidth, availability, etc. may also be important to customers,

### BRIEF DESCRIPTION OF THE DRAWINGS

The following detailed description references the drawings, wherein:

FIG. 1 is a block diagram of an example architecture for verifying SLA compliance of NFCs based on a SFG;

FIGS. 2A-2B are block diagrams illustrating example SLA violations that can be verified by a SLA verifier;

FIGS. 3A-3B are block diagrams illustrating example paths, rules, and configurations that are input into a SLA verifier;

FIG. 4 is a block diagram illustrating generation of an example stateful forwarding graph (SFG);

FIG. 5 is a block diagram illustrating another example of performance augmented stateful forwarding graph (SFG);

FIG. 6 is a flowchart of an example process to verify SLA compliance of NFCs based on a SFG;

FIG. 7 is a flowchart of an example process to verify SLA compliance of NFCs based on a SFG;

FIG. 8 is a flowchart of an example process to verify SLA compliance of NFCs based on a SFG;

FIG. 9 is a block diagram of an example network device to verify SLA compliance of NFCs based on a SFG.

### DETAILED DESCRIPTION

Service Level Agreements (SLAs) generally specify performance assurance metrics, such as, packet loss, delay, jitter, bandwidth, network availability, etc. Failure to meet SLA guarantees by network service providers can result in poor application performance and significant revenue loss. SLA compliance verification generally refers to verifying whether a network function chain in a given configuration can deliver the performance within the SLA bounds.

Emerging new network environments, such as, Software-Defined Networks (SDN) and Network Function Virtualization (NFV), generally involve increased dynamics of network routing and resource allocation. In particular, SDN allows for fine-grained flow-level dynamic routing, which can be triggered by various network state changes (e.g., failures). On the other hand, NFV allows for virtualizing and scaling network services up or down with changes in demand. Upon workload changes or failures, flows may be steered to different paths or through different middleboxes to react to the changes. Therefore, service providers would want to verify that SLAs are satisfied in these new dynamic settings.

Currently, network verification has been used to verify network reachability properties and detect configuration errors. Such network verification techniques merely focus on verifying basic connectivity invariants, such as, loop free-ness, isolation, and reachability. However, while connectivity may be a basic guarantee provided by the network, guarantees on performance metrics, such as, latency, packet loss rate, bandwidth, availability, etc., may also be important. Verifying these performance properties are generally referred to as SLA verification.

In the solution herein, SLA compliance and/or violations are checked via a two-step SLA compliance checking mechanism that comprises both static verification and online measurements. As used herein, the term “mechanism” generally refers to a component of a system or device to serve one or more functions, including but not limited to, software components, electronic components, electrical components, mechanical components, electro-mechanical components, etc.

Moreover, the example SLA-verifier includes an online SLA monitoring component. With the online SLA monitoring component in the example SLA-verifier, the solution herein could be used to detect misconfigurations even before deployment. Therefore, even though the traffic and network environment changes dynamically, by analyzing the traffic distribution and the configuration of the network and middleboxes, the example SLA-verifier can identify possible SLA violations using static analysis even before traffic arrives. The static verification and online measurement can be combined to accommodate the inaccuracy in traffic distribution estimation.

Architecture

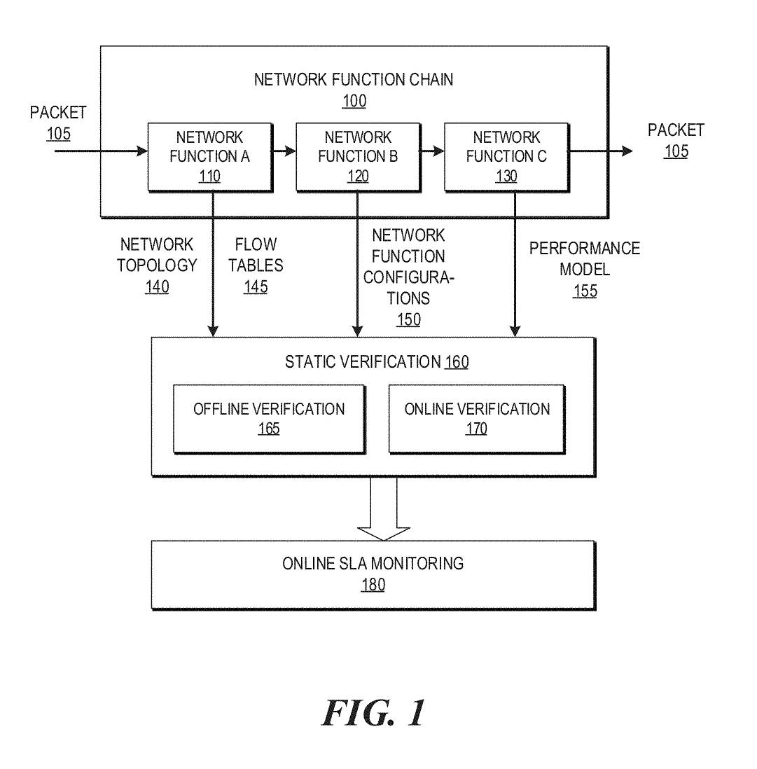

FIG. 1 is a block diagram of an example architecture for selectively monitoring a path in a network function chain based on probability of service level agreement (SLA) violation. FIG. 1 includes a network function chain 100 that includes a plurality of network functions, such as network, function A 110, network function B 120, network function C 130, etc. A packet 105 in a flow may traverse network function chain 100. The flow may be subject to a SLA. The example architecture includes a SLA-verifier that verifies whether the network function chain meets the expected behavior as specified in the SLA while providing service to the flow, including packet 105.

The SLA-verifier has a static verification module 160 and an online SLA monitoring module 180. Multiple queries can be generated using a query language to inquire network function models by static verification module 160 to determine whether a specified network invariant is satisfied in a particular network function chain.

The inputs to the SLA-verifier include network topology 140, SDN flow tables 145, Network Function (NF) configurations 150, and the performance model 155 that are generated from historical measurements. Examples of the distribution model include delay distribution and load distribution on each link. For service chaining applications, when flows traverse a sequence of NFs, NF performance models are combined to verify the SLA-compliance by the sequence of the NFs. The inputs to the SLA-verifier are described in more details in the section below.

The main component of the SLA-verifier is a static verification module 160. Static verification module 160 includes two sub modules, namely, an offline verification module 165 and an online verification module 170. Offline verification module 165 generally takes a snapshot of the configuration and answers various performance related queries. Furthermore, offline verification module 165 checks if there is any SLA violation given the current configuration.

Using the offline analysis results, online verification module 170 builds a stateful forwarding graph (SFG). At run time, upon any configuration or routing changes, online verification module 170 uses the stateful forwarding graph to identify whether the changes in configurations or routes lead to an SLA violation. In one example, a minimum bandwidth guarantee may not be met because of a misconfiguration of rate limiters, or classifying a flow into a low priority class, or mistakenly allocating a smaller than normal amount of bandwidth to the virtual links. In network function virtualization (NFV) scenarios, the selection of Virtualized Network Function (VNF) placements for a particular network function chain could be sub-optimal. For example, assuming that one NF is in one datacenter or Point of Presence (PoP) and the next NF in the same network function chain is in another PoP. If the propagation delay between the two PoPs is larger than the latency guarantee, then the latency clause in the SLA will not be satisfied even if none of the nodes along the path is congested.

Note that the SLA-verifier may find a path that has not violated the SLA yet, but could have a high probability of violating the SLA when the traffic dynamics change. This is because the traffic or performance distribution input to the SLA-verifier may not be accurate. Therefore, static verification module 160 is coupled with an online SLA monitoring module 180. Online SLA monitoring module 180 uses the verification results to allocate the monitoring resources and to improve the probability of detecting SLA violations.

SLA Violation Examples

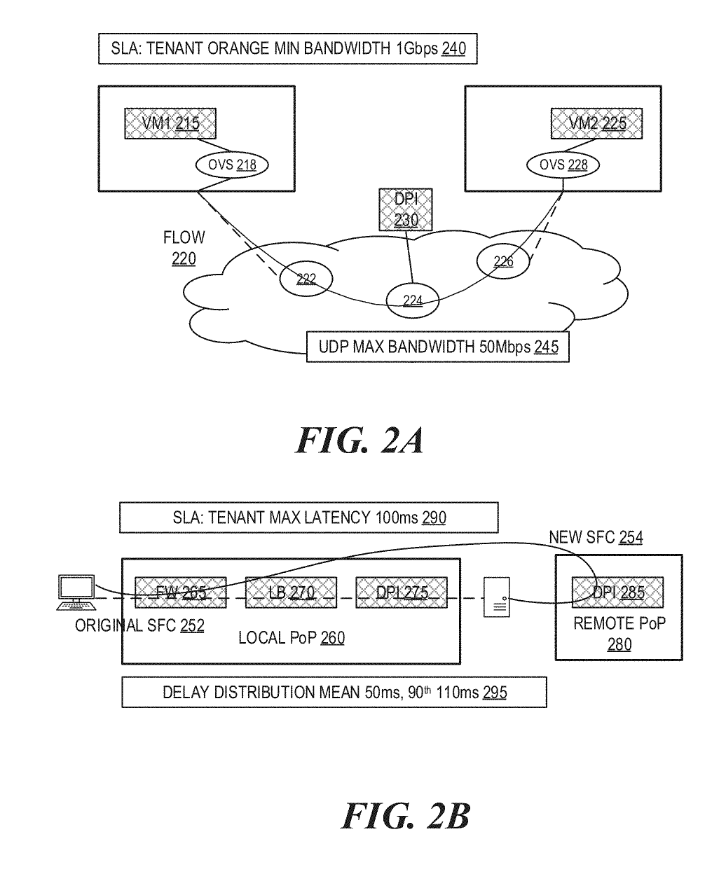

FIGS. 2A-2B are block diagrams illustrating example SLA violations detected by an online SLA monitoring component 250. SLA-Verifier aims at detecting two types of SLA violations, namely, SLA violations due to misconfiguration and SLA violations due to probabilistic violations.

Specifically, FIG. 2A illustrates a SLA violation due to misconfiguration. In this example, a SLA 240 is guaranteed for a tenant Orange that its minimum bandwidth provided by the network function chain is 1 Gbps. This can be provided, for example, by setting the rate limiter in the hypervisor to 1 Gbps for a virtual machine, e.g., VM 215 or VM 225, of this tenant. A virtual machine generally provides functionality to execute entire operating systems. A hypervisor often uses native execution to share and manage hardware, allowing for multiple environments that are isolated from one another, yet exist on the same physical machine. Hypervisors generally use hardware-assisted virtualization, virtualization-specific hardware from the host CPUs.

Open vSwitch, such as, OVS 218 and OVS 228, generally refers to a virtual multilayer network switch that enables effective network automation through programmatic extensions, while supporting standard management interfaces and protocols. In addition, Open vSwitch is designed to support transparent distribution across multiple physical servers by enabling creation of cross-server switches in a way that abstracts out the underlying server architecture.

The path of a flow 220 originating from VM 215 and destined to VM2 225 includes switching nodes 222, 224, 226, etc. Moreover, there is a Deep Packet Inspection (DPI) network function (NF) 230 along the path. In this example, switch 224 connecting to DPI NF 230 has a configuration 245 that imposes a rate limit on any user datagram protocol (UDP) flow to 50 Mbps in order to prevent denial-of-service (DoS) attack to the DPI. Thus, flow f220 of this tenant, which happens to be a UDP flow, experiences a maximum rate of 50 Mbps. As a result, the rate limit on this UDP flow 220 violates the original SLA 245.

With the example SLA-verifier, the performance metric can be defined on different header space. When doing path analysis, different performance metrics can be composed across the header space. For example, in FIG. 2A, the QoS configuration for tenant Orange at OVS 218 may be composed with the configuration of UDP at intermediate switch 224. One example composition may yield the following rule: a UDP flow from VM1 215 to VM2 225 has a maximum bandwidth of 50 Mbps. New algebra may be defined for operations on the composed quantitative performance metrics.

In this case, switch 224 can be configured with a rule associated with a high priority to create an exception for this flow. For example, the high priority rule may allow the UDP flow 220 to have a maximum bandwidth of 1.2 Gbps to avoid SLA violations.

FIG. 2B illustrates an example SLA violation due to probabilistic violation. In this example, a tenant's traffic traverses a network function chain with a Firewall (FW 265), a Load Balancer (LB 270), and a DPI NF 275. The SLA 290 for this network function chain specifies a maximum latency of 100 ms. This SLA is easy to satisfy when all the NFs are in the same PoP, such as, Local PoP 260 as in the original service function chain (SFC) 252.

However, upon detecting a failure or a traffic spike, a network controller may decide to use the DPI 285 in a remote PoP 280. Assuming that the new SFC 254 has a mean delay distribution of 50 ms, whereas the 90th percentile of the inter-PoP link delay is 110 ms. Thus, the new SFC 254 will have at least 10% chance of violating SLA 290.

In this case, a SLA monitor can monitor the flow through the new SFC 254 and computes a probability of SLA violation. The SLA verifier can then allocate the resource (e.g., hardware traffic counters) based on the probability of SLA violations.

SLA Verification

Advanced network functions may have complex configuration knobs that can affect performance depending on the states. For example, a load balancer performs rate limiting if the number of requests exceeds a certain threshold. Existing measurement indicates that the NFs' performance also depends on its internal states. Thus, a stateful performance model for NFs is constructed for SLA verification.

A. Example SLA Verification Queries

Representative examples of SLAs that the SLA verifier can verify include:

1. What is the minimum and maximum bandwidth for all flows from A to B?

2. What is the average end-to-end latency for all flows that B can receive?

3. Does QoS class X always have higher bandwidth than QoS class Y?

4. Under a single failure, no link utilization will exceed 95%.

5. The probability of any flow experiencing latency>300 ms is below 0.001.

The first example question is similar to finding out the reachability from node A to node B. In addition, the SLA verifier can also identify the rate limiting, priority setting, buffer sizing configurations along the path, and compute the available bandwidth along the path from node A to node B. The second example question involves verifying the latency performance metric. Here, the SLA verifier can reversely trace the flows destined to node B hop-by-hop, and computes the average delay across the flows. The third example question inquires the comparison between two classes of packets, which can be represented as two disjoint cubes in the hyper-dimensional header space. The fourth example question generally relates to the link utilization after the failure given the current flow rules. Lastly, the fifth example question checks if the probability of a latency violation is bounded by a threshold.

All of these queries are examples of SLA verification. Operators may use the SLA verifier to check the SLA compliance. If any SLA violation is detected, the SLA violations can be reported to the operators, who can further diagnose the cause. For example, a minimum bandwidth guarantee may not be met due to a misconfiguration of rate limiters. Alternatively, the minimum bandwidth guarantee may fail because the virtual links are allocated with a small amount of bandwidth. Moreover, the network controller may assign too many flows on a virtual network but the allocated bandwidth for a virtual link is too small.

Also, the selection of VNFs for a particular network function chain could be sub-optimal. For example, one VNF may be in one PoP, and the next VNF in the same network function chain may be in another PoP. The long-distance transmission delay is so large that the latency guarantee will not be satisfied even if none of the nodes along the path is congested.

B. Verification Approach

1. Packet Space

The SLA verification is performed over a multi-dimensional space: <H, V>. Here, H is the header space of the packets, and V is the value space associated with the header. An example can be <1xxx10, 10 ms>, which represents the average end-to-end latency for the packets matching 1xxx10 pattern. This pattern is used to specify the traffic originated from a source IP of 1xx, and destined to a destination IP of x10. The value can be defined according to the set of SLA performance metrics of interest, including, for example, latency, throughput, bandwidth, hop count, link load, jitter, etc.

The goal of SLA verification process is to identify the performance that a set of packets will experience in the network and verify that the performance complies with the given SLAs for this set of packets. Since the set of performance metrics is tightly related to the path and the network function chain that the packet traverses, in most cases, the SLA verification involves computing the path and the network functions that the packet traverses.

2. Equivalent Class (EC)

At the high level, the SLA verification computes the performance metrics by the process of searching the path that a packet header space traverses. Specifically, in a network, a set of packets that are treated equivalently from when they enter the network till they exit the network forms an equivalent class. The SLA verifier first identifies the equivalent class by parsing the flow rules and the NF configurations. In this process, the SLA verifier identifies a plurality of paths that the set of packets traverses through, and cumulatively computes the set of SLA performance metrics for this equivalent class.

3. Set Operation

Finding the equivalent class is a process of refining the packet space according to the network configurations. Given a set of packets <H1,V1>, and the rule defined against H2 resulting in performance V2 (<H2,V2>), the SLA verifier can compute a sub-space and a performance value.

To do so, a set of operations are defined between <H1,V1> and <H2,V2>. The set of operations include, for example, intersection, union, complement, difference, etc. It can be further extended depending on the performance metrics.

(1) Intersection

<H1,V1>∩<H2,V2>=<H1∩H2, V1∩V2> finds the intersection of the two spaces, and computes a new value for the sub-space. H1∩H2 is a standard wildcard based set intersection. The intersection can often be used to compute the impact of a rule on the flows traversing this switch. The value operation depends on the definition of the SLA performance metrics. Specifically, for maximum bandwidth, V1∩V2=min(V1, V2); for maximum latency, V1∩V2=min (V1, V2); for average latency, V1∩V2=avg (V1, V2); for minimum latency, V1∩V2=max (V1, V2); for maximum hop count, V1∩V2=max(V1, V2); etc.

(2) Union

<H1,V1>∪<H2,V2>=<H1∪H2, V1∪V2> finds the union of the two values in the joint space of H1 and H2. Union can be used when two flows are merged into one flow in the downstream path, and thus the SLA verifier can compute the combined performance metrics. For example, for maximum bandwidth, V1∪V2=max(V1, V2); for maximum latency: V1∪V2=max (V1,V2); for average latency, V1∪V2=avg (V1, V2); for minimum latency: V1∪V2=min (V1, V2); for maximum hop count, V1∪V2=max(V1, V2); etc.

(3) Complement

<H,V>-<H1,V1> can be represented using the intersection and union operations. When a subset of a packet space is handled specially, the SLA verifier can use the complement operation to compute the set of the remaining packets in the original space, as well as the performance metrics associated with it.

(4) Difference

<H1,V1>-<H2,V2> also can be represented using the intersection and union operations.

4. Rule Refinement

In an actual box configuration, there are usually multiple rules, and these rules may overlap with each other. Thus, the rules can be refined first to determine which rule's action would be applied. For example, assuming that there is a high-priority rule with flow matching and next hop (11 * *; n₁) and a low-priority rule with (1 * * *; n₂) on the same box, the overlapping flow space is 11 * *. If a symbolic flow * * * * is input to this box, and rules are matched one by one, the final output would be (11 * *; n₁) and (1 * * *; n₂) causing incorrect verification result: flows 11 * * to arrive at multiple destinations. Therefore, the SLA-verifier first refines all rules in a box. For original rules, the SLA-verifier expects to output a new set of rules where (1) new rules do not overlap with each other, (2) cover the same space with the original set, and (3) each flow would be taken same actions on in both rule sets.

The RefineRule function in Table 1 performs this task. It first sorts all original rules in descending order according to priority breaking ties by prefix length. Then, the sorted rule set is iterated through. Each rule is refined by subtracting the union of previous rules until a refined rule set that satisfies the three requirements is finally obtained.

TABLE 1
Example RefineRules Function

```
function REFINERULES(B)
  for b 2 B do
    rules := b.rules.sort( )
    refRules := 0
    for r ϵ rules do
      newRule := r − Union(refRules)
      refRules.add(newRule)
    b.rules := refRules
```

5. Flow Space Verification

Moreover, the example SLA-verifier models network devices' behaviors. Specifically, the SLA-verifier statically computes all possible flow paths in the network. To achieve this, the SLA-verifier starts a symbolic flow from each end host, adopt breadth first search (BFS) to find a plurality of paths whose length is smaller than K. In each network box, the symbolic flow matches each rule using f operation. The symbolic flow is then refined and split as it matches with fine-grained rules, and forwarded to its next hop.

The path-searching algorithm computes k-hop paths originated from src. It initially puts (src, *) into candidate paths, meaning that the flow starts from src with wildcard state *. During searching, in each round, a candidate path is chosen, and then the incoming flow matches with each rule. Once the incoming flow matches a rule, the outgoing flow is computed using the transformation function. The next hop and the outgoing flow is appended into the path. Also, the internal state, as well as the aggregated performance vector of the box, are also recorded. If the next hop is an end host or drop, this path of communication is complete. Otherwise, the flow reaches an intermediate network box and is put back into the candidate set.

Table 2 below shows the verification code for flow space.

TABLE 2
Example Flow Space Verification Function

```
function VERIFYFLOWSPACE(src)
    paths := [symbol]   , cand := [symbol]
    flow := *, path := [(src, *)], perf := *
    cand.add( (flow, path, perf) )
    while cand ≠ [symbol]   do
        c := cand.pop( )
        if c.length ≥ K then continue
        flow := c.flow, box:= c.path.lastHop( )
        for r ϵ box.rules do
            (f, sᵢ, T, s₀, n) := r
            if flow ∩ f == [symbol]   ; then continue
            f₀ := T(flow ∩ f)
            path := c.path.append( (n, sᵢ) )
            perf := c.perf ∪ b.perf
            if n == drop or n ϵ EndHosts then
                path.add( (f₀, path, perf) )
            else
                cand.add( (f₀, path, perf) )
```

6. Box States Verification

Flow space verification guarantees possible data paths for flows in the topology without considering box states along the path. In the final output of flow verification, flow paths are an output together with the box states that satisfy that path (i.e., P(b,s)). For stateful network verification, SLA-verifier also can prove or disprove that the states of boxes along the path is satisfiable or unsatisfiable. In order to do this, states verification turns states into packet histories. In each box, a certain state would be triggered after processing certain sequence of packets. For the state s_{b} of each box b along a data path, SLA-verifier computes the possible packet history h_{b} that can trigger this state. Then, the SLA-verifier checks whether there exists a packet sequence that satisfies all these histories to confirm whether this data path is satisfiable (i.e., ∪_{b}h_{b}==ø). For example, a cache state “cached flow f” can be expressed by history * f *, and a firewall state “at least 2 connections of flow f” can be expressed by * f * f *. Then, to check whether both states can be satisfied simultaneously is equivalent to check whether * f * ∪ * f * is ø.

Table 3 below shows an example state verification function in the SLA-verifier.

TABLE 3
Example State Verification Function

```
function VERIFYSTATES( path )
    for (b, s) ϵ path do
        H_{b} := GETHISTORY(b, s)
    return ∩ H_{b} == [symbol]
```

7. Performance Verification

Performance verification includes both performance configurations (e.g., QoS bandwidth allocation) and probabilistic violations (e.g., possible burst in load). Among various performance metrics, hop count, bandwidth and latency are example flow-based metrics. That is, the performance metric accumulates (e.g., the join operation u) along the flow's path. On the other hand, link load is an example link-based metric. As such, the performance metric accumulates multiple flows' traffic load on each link they traversed. The SLA-verifier outputs a flow with its accumulated performance vector. Thus, the flow-based metrics can be verified easily. For link-based metrics, the flow's performance metric (e.g., load) may be added to the link, and then the metric is verified per link.

When verifying a configuration metric (e.g., hop count, QoS bandwidth, etc.), the metric is compared with a predetermined goal. For example, the SLA-verifier can verify whether a flow is completed within 10 hops, or whether a flow is allocated a bandwidth of 10 Mbps along its path. When verifying a probability (e.g. latency of a flow or load on a link), the accumulated (u) metric is checked by computing the probability of performance violation. For example, with latency accumulated along a flow's path, SLA-verifier can verify whether 90% of packets can be delivered within 100 ms by convoluting the probability density function.

Table 4 below shows an example performance verification function in the SLA-verifier.

TABLE 4
Example Performance Verification Function

```
function VERIFYPERFORMANCE(paths)
    for p ϵ paths do
        VERIFY(p.perf)
    for l ϵ E do
        l.perf := ∪ _{p ϵ paths} p.flow.perf
        VERIFY(l.perf)
```

Table 5 below shows an example SLA-verifier.

TABLE 5
Example SLA Verifier

```
function SLA-VERIFIER(G(B, E))
    REFINERULES(B)
    paths := ∪ _{bϵB} VERIFYFLOWSPACE(b)
    for p ϵ paths do
        VERIFYSTATES(p)
    VERIFYPERFORMANCE(paths)
```

Stateful Forwarding Graph

Performing checks in real-time on a large network topology with complex network boxes is challenging. One approach to speed up the checking process is slicing the network to equivalence classes (EC). Each EC is generally defined as a set of packets that are treated the same across the network. The set of packets in an EC satisfies both quantitative criteria and stateful criteria.

According to the quantitative criteria, packets in the same EC not only traverse the same path, but also belong to the same performance group. Here, the performance group is defined by parsing performance-related configurations and by analyzing the performance distribution.

For packets that traverse a sequence of NFs, their path may be changed according to the status of the intermediate NF. This is also referred to as dynamic service chain. According to the stateful criteria, packets in the same EC will have the same treatment in any NF states

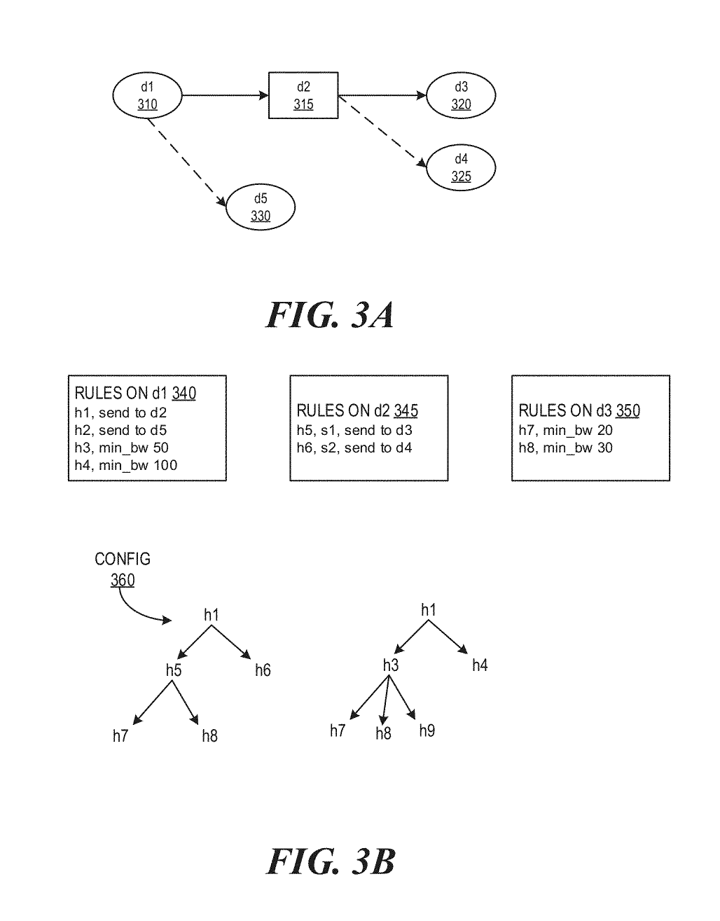

FIGS. 3A-3B are block diagrams illustrating example paths, rules, and configurations monitored by an online SLA monitoring component of the example SLA verifier. The network topology is shown in FIG. 3A. There are four switches (e.g., d1 310, d3 320, d4 325, and d5 330) and one stateful middlebox d2 315. For example, d2 315 can be an intrusion detection system (IDS). If the traffic is normal, d2 315 sends the traffic to d3 320, otherwise d2 315 sends the traffic to d4 325.

FIG. 3B shows the rule tables and relationship between headers. For example, rules on d1 340 may indicate that packets in header space h1 are to be sent to d2; packets in header space h2 are to be sent to d5; packets in header space h3 are guaranteed a minimum bandwidth of 50 Mbps; packets in header space h4 are guaranteed a minimum bandwidth of 100 Mbps, etc. As another example, rules on d2 345 may indicate that packets in header space h5 having state s1 are to be sent to d3; packets in header space h6 having state s2 are to be sent to d4; etc. Moreover, rules on d3 350 may indicate that packets in header space h7 are guaranteed a minimum bandwidth of 20 Mbps; packets in header space h8 are guaranteed a minimum bandwidth of 30 Mbps; etc.

Configuration 360 shows an example relationship between headers. In this example, header space h1 may have sub-spaces h5 and h6. In addition, header space h5 may have two sub-spaces h7 and h8. In another configuration, header space h1 may have sub-spaces h3 and h4. Furthermore, header space h3 may have three sub-spaces h7, h8, and h9.

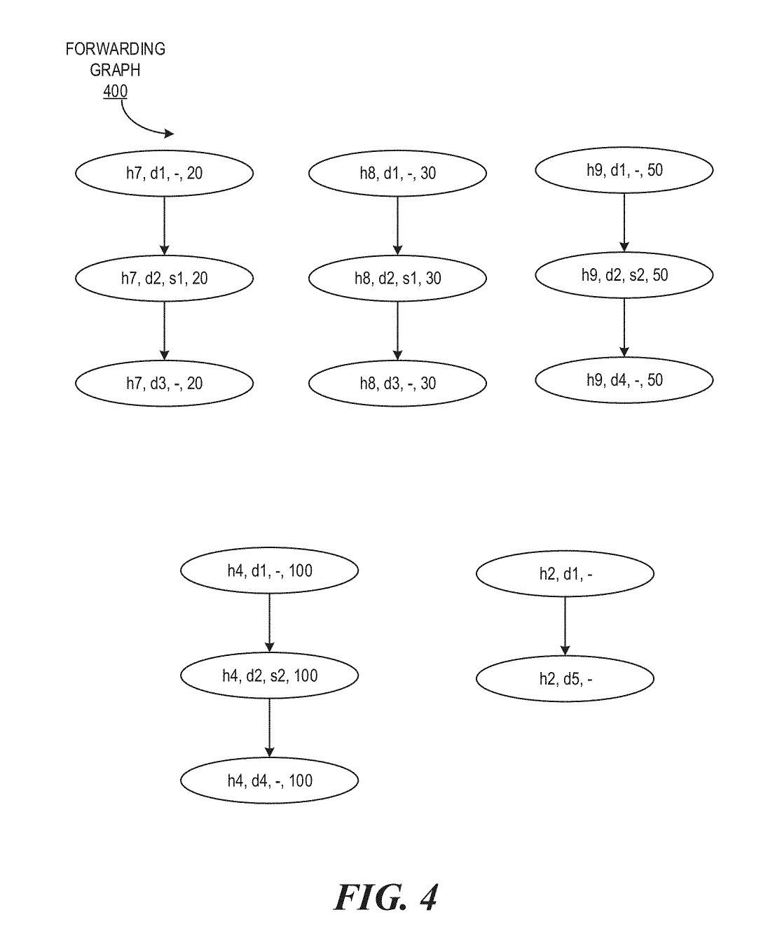

Using the inputs shown in FIGS. 3A-3B, the SLA-verifier can construct a QFG. FIG. 4 is a block diagram illustrating an example quantitative forwarding graph (QFG) 400. Furthermore, in QFG representation, whenever the network device configurations are updated, it is easy to find the affected QFG nodes as well as their dependencies. Thus, the verification can be limited to only those affected flows and devices.

Stateful Forwarding Graph (SFG) 400 generally represents how packets are forwarded, what performance they are getting, and what NF states they change. In SFG 400, each node is denoted as a tuple of packet header space, device, state, and performance group, e.g., (H; D; S; G), representing any packet in the packet header space H arriving at a network device (switch or NF) D, when the network device is at a particular state S with performance G. An edge pointing from one node (H₁; D₁; S₁; G₁) to another (H₂; D₂; S₂; G₂) means when a packet in H₁ arrives at D₁ with state S₁ in performance group G₁, it will be modified to H₂ and forwarded to a device D₂ at state S₂ in performance group G₂. If D₁ does not modify the packet header, then H₁ is equal to H₂. If the packet H₁ does not trigger the state transition, S₁ is equal to S₂. If both devices differentially treat the packet in the same way, then G₁ is equal to G₂.

To build the SFG 400, the SLA-verifier parses the rules in all switches and NF configurations. For tables in each network device (switch or NF), the SLA-verifier groups the rules based on the actions. Then, the SLA-verifier creates one node for each group, which contains four fields (H; d; s; A) corresponding to header, device, state, and action respectively. Next, the SLA-verifier computes the path starting from each node by tracing its next hop in the action. For each hop, the SLA-verifier creates a corresponding node and inserts the node to the path. Meanwhile, the SLA-verifier also back tracks to split the parent nodes along the path. For example, as shown in configuration 360 in FIG. 3B, h1 is split to h7, h8, and h6. Nodes are added to the path iteratively until the next hop is “to drop” or is outside the network.

Next, given a header space h, the SLA-verifier find a plurality of paths that intersect with h, and go through the nodes of each path. While traversing each path, the SLA-verifier composes the performance metrics. In the example shown in FIG. 4, minimum bandwidth is chosen as the performance metrics. Thus, the composition could be the minimum between the current value of the bandwidth of the path and the bandwidth of the nodes in SFG.

SLA Verification Using SFG

Building the example SLA verifier described herein involves two parts. First, the system may build a performance-augmented SFG graph (also referred to as “P-SFG”). Second, the system traverses the performance-augmented SFG graph for various queries.

1. Performance Metrics

During the graph building process, the performance values associated with each node can be updated according to the following two metrics.

(1) Bₙ=min(bₙ,Bₙ₋₁): the cumulative bandwidth of a path with n hops at hop n is the minimum value of the cumulative value of the earlier n−1 hops and the bandwidth value of the current hop—bₙ.

(2) Lₙ=Lₙ−1+Iₙ: the cumulative latency of an n hop path is the summation of the n−1 hop path latency and the latency of the current hop. The latency can be computed by estimating the maximum queuing delay according to a queuing model or based on the propagation delay.

In some implementations, for each hop or link in the network, its performance metric can be described by a performance vector P=(p₁, p₂, . . . , pn). Each dimension of the vector may describe a certain performance metric, for example, hop count, bandwidth, link load, latency, etc. Such performance metrics can be joined. The join of two performance vectors results in a third vector, in which each dimension is the join of the two original vectors' corresponding dimensions. Thus, for P₁=(p₁₁, p₁₂, . . . , p₁ₙ); P₂=(p₂₁, P₂₂, . . . , p₂ₙ), P₁∪P₂=(P₁₁ ∪p₂₁, p₁₂∪p₂₂, . . . , p₁ₙ∪p₂ₙ). Specifically, the join operation of different metrics can be defined differently as illustrated in Table 6 below.

TABLE 6
Definition of Join Operations of Different Performance Metrics

| Metric | Definition |
|---|---|
| Hop Count | p₁ + p₂, usually p₁, p₂ is 1 on each hop. |
| Bandwidth | min(p₁, p₂), p₁ and p₂ are defined in QoS. |
| Latency/Load | ${\int }_{- ∞}^{∞} {f}_{1} ( x - t ) {f}_{2} ( t ) d t , {p}_{1} \sim {f}_{1} , {p}_{2} \sim {f}_{2}$ |

As shown in Table 6, the join operation of some performance metrics (e.g., hop count, QoS bandwidth, etc.) is straightforward. For example, the performance metric of hop count is joined by summing up per-hop count 1. As another example, the performance metric of QoS bandwidth is joined by computing the minimum bandwidth assignment in QoS policies along the path. Moreover, the scope of the join operation can be extended to performance metrics with varying values, for example, performance metrics that follow a distribution. Specifically, the link load and latency are often not a constant value in the whole duration. Rather, their value follows a distribution curve. In these scenarios, the SLA verifier can compute the distribution of aggregated link load based on each individual flows' distribution. Similarly, the SLA verifier can accumulate the latency based on the distribution of per-hop latency. In particular, the SLA verifier can define the join operation of performance metrics in the form of at least two distributions to be the convolution of the two distributions' probability density function. The mathematical expression is shown in Table 6 above.

2. Performance Augmentation

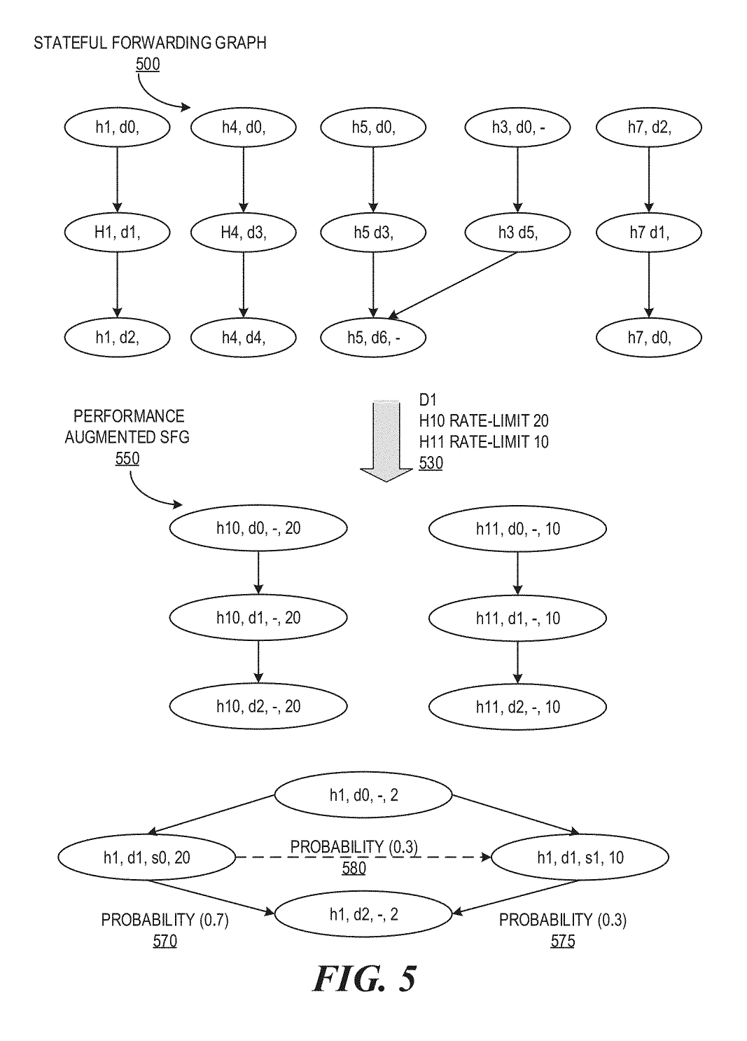

Generating the performance-augmented SFG (P-SFG) 550 from a SFG 500 generally involves the following operations. First, the SLA-verifier can augment nodes in the SFG 500 with performance metrics. Specifically, each node in the P-SFG 550 contains four fields: <header, device, state, performance>. The value shown in FIG. 5 is the minimum bandwidth extracted from the rate-limit configurations, e.g., at D1, H10 has a rate limit of 20 Mbps and H11 has a rate limitation of 10 Mbps. The performance field in each node in the P-SFG generally refers to the performance (e.g. latency, bandwidth, etc.) that the packets in a header space will experience on a particular device when it is in a particular state.

Second, the SLA-verifier can split nodes if they are in different performance groups. In this example, although H10 and H11 pass through exactly the same path as they are in the same equivalent class in SFG 500, they are split to two separate nodes in the P-SFG 550, because they are configured with different bandwidth. Specifically, H10 is configured with a maximum bandwidth of 20 Mbps, whereas H11 is configured with a maximum bandwidth of 10 Mbps.

Next, the SLA-verifier can augment state transition edge with probability. Because middleboxes may forward the packet to different paths depending on their different internal states, the distribution of states can be modeled using a probability model. Specifically, the probability can be obtained from prior-measurement. For example, the bottom part of FIG. 5 shows that a middlebox D1 has two states S0 and S1. There is 0.7 (70%) probability 570 that the middlebox D1 is in state S0, and 0.3 (30%) probability 575 that the middlebox D1 is in state S1. State S0 and state S1 are associated with different bandwidth limits. Moreover, there is a 0.3 probability 580 that the middlebox D1 may transition from state S0 to state S1. Using this probability model, the SLA verifier can compute the probability of experiencing a bandwidth limit of 10 Mbps at D1.

3. Stateful Forwarding Graph Traversal

In the above example, the P-SFG may be traversed to compute the average bandwidth for paths from a particular source s. Specifically, the SLA verifier can use a breadth first search on the P-SFG. At each node during the traversal, the SLA verifier can compute the cumulative value from a particular source to the current node.

An example pseudocode for finding the bandwidth of all paths from s is shown below in Table 7.

TABLE 7
Stateful Forwarding Graph Traversal

```
Struct values {<node,flow>,...>}
Struct states {P(b,s),...}
Struct Path {states, values}
Function FINDBANDWIDTH(s,G)
    Paths = Φ, candidates = {Path(*,<(src,*)>)
    While candidates not Φ do
        c= candidates.pop( )
        <device,flow>=GetNextHop (c)
        for r in device.rules do
            < f, sin, T, sout, next>=r
            fout = T(flow∩f)
            p.values = c. values.append(next,fout)
            p.states = p.states ∧ P(device,sin)
            if next = drop ∨ next is End_Hosts
                paths.add(p)
            else
                candidates.add(p)
return paths
```

Processes to Verify SLA Compliance of NFCs Based on a SFG

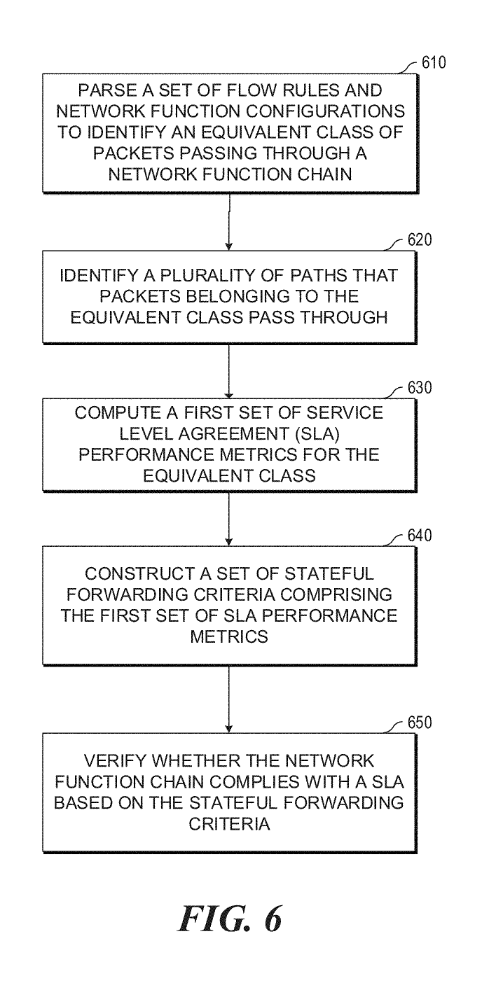

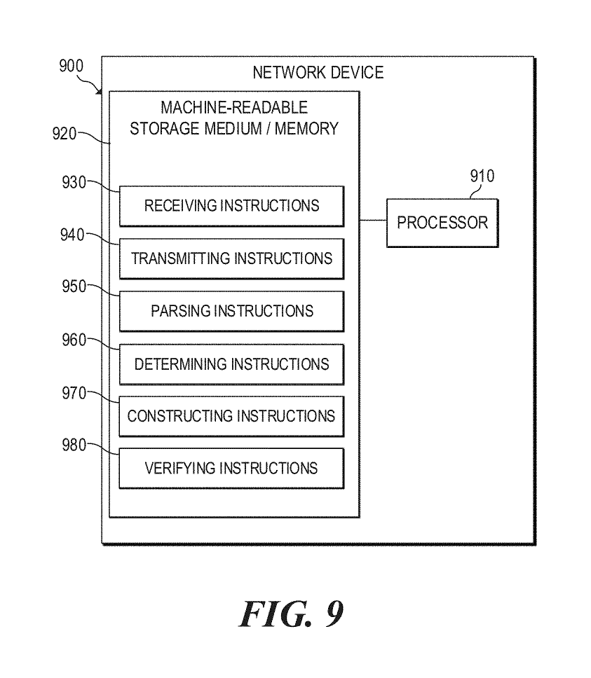

In discussing FIGS. 6-8, references may be made to the components in FIGS. 1-5 to provide contextual examples. In one implementation, the verification system described in FIG. 1 executes operations 610-650, 710-750, and 810-850 to verify SLA compliance of NFCs based on a SFG. Further, although FIGS. 6-8 are described as implemented by a network device, it may be executed on other suitable devices or components. For example, FIGS. 6-8 may be implemented in the form of executable instructions on a machine-readable storage medium (or memory) 920 as in FIG. 9.

FIG. 6 is a flowchart of an example process to verify SLA compliance of NFCs based on a SFG. Specifically, a network device may parse a set of flow rules and network function configurations to identify an equivalent class of packets passing through a network function chain (operation 610). Then, the network device may identify a plurality of paths that packets belonging to the equivalent class pass through (operation 620). Further, the network device can compute a first set of Service Level Agreement (SLA) performance metrics for the equivalent class (operation 630). Moreover, the network device can construct a set of stateful forwarding criteria comprising the first set of SLA performance metrics (operation 640), and verify whether the network function chain complies with a SLA based on the stateful forwarding criteria (operation 650).

The stateful forwarding criteria generally include a plurality of nodes corresponding to the same path, and each node corresponds to a particular performance group on a particular network device.

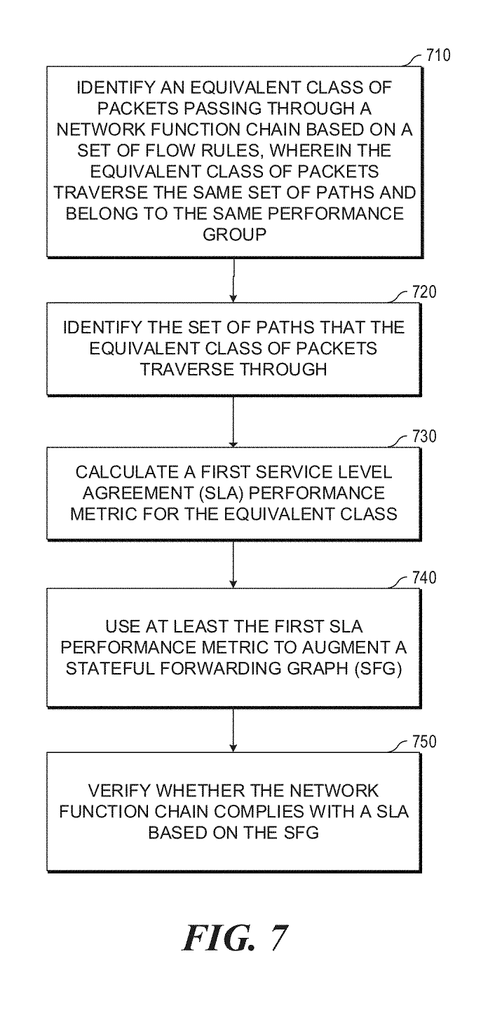

FIG. 7 is a flowchart of another example process to verify SLA compliance of NFCs based on a SFG. In this example, a network device can identify an equivalent class of packets passing through a network function chain based on a set of flow rules (operation 710). Here, the equivalent class of packets traverse the same set of paths and belong to the same performance group. Moreover, the network device can further identify the set of paths that the equivalent class of packets traverse through (operation 720). Also, the network device can calculate a first set of Service Level Agreement (SLA) performance metrics for the equivalent class (operation 730). Then, the network device uses at least the first set of SLA performance metrics to augment a stateful forwarding graph (SFG) (operation 740). Further, the network device can verify whether the network function chain complies with a SLA based on the SFG.

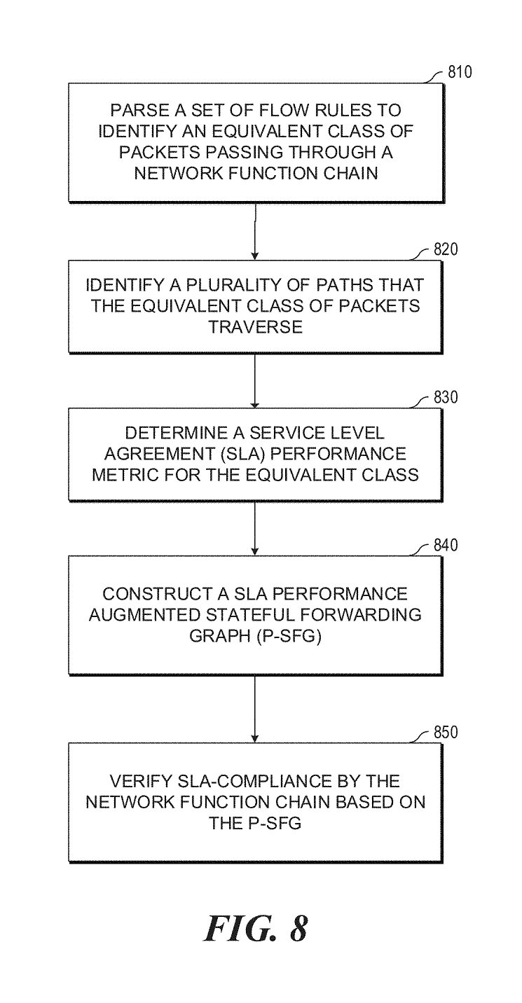

FIG. 8 is a flowchart of yet another example process to verify SLA compliance of NFCs based on a SFG. Here, a network device first parses a set of flow rules to identify an equivalent class of packets passing through a network function chain (operation 810). Then, the network device may identify a plurality of paths that the equivalent class of packets traverse (operation 820). Next, the network device can determine performance specified in a Service Level Agreement (SLA) for the equivalent class (operation 830). Furthermore, the network device can construct a SLA performance augmented stateful forwarding graph (P-SFG) (operation 840). Finally, the network device can verify SLA compliance by the network function chain based on the P-SFG.

In some implementations, the network device can compute a union of the first set of SLA performance metrics for a first flow and a second set of SLA performance metrics for a second flow when the first flow and the second flow merge into an aggregated flow.

In some implementations, the network device can compute an intersection of the first set of SLA performance metrics for a first flow and a second SLA performance metric for a second flow to evaluate impact of an aggregated flow including both the first flow and the second flow on the network device.

In some examples, the network device can compute a complement sub-space and performance value corresponding to the first set of SLA performance metrics. In some examples, the network device can compute a difference between sub-spaces and performance values corresponding to the first set of SLA performance metrics for a first flow and a second set of SLA performance metrics for a second flow.

In the above examples, the performance group can be defined by different values of the first set of SLA performance metrics. The first set of SLA performance metrics may include, for example, a hop count, a bandwidth measurement, a link load measurement, and a latency measurement. Moreover, the set of flow rules may include a plurality of intersection rules, union rules, complement rules, and difference rules.

The equivalent class of packets not only traverse the same path and belong to the same performance group, they also have the same treatment in different network function states.

In some examples, the first set of SLA performance metrics follows a statistic distribution. Therefore, the first set of SLA performance metric can further be joined with a second set of SLA performance metrics (which also follows a statistic distribution) for a second path in the network function chain by computing a convolution of probability density functions associated with two distributions corresponding to the first set of SLA performance metrics and the second set of SLA performance metrics.

Network Device to Verify SLA Compliance of NFCs Based on a SFG

FIG. 9 is a block diagram of an example network device with at least one processor 910 to execute instructions 930-980 within a machine-readable storage medium (or memory) 920 to verify SLA compliance of NFCs based on a SFG. As used herein, “network device” generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like.

Although the network device 900 includes at least one processor 910 and machine-readable storage medium (or memory) 920, it may also include other components that would be suitable to one skilled in the art. For example, network device 900 may include an additional processing component and/or storage. In another implementation, the network device executes instructions 930-980. Network device 900 is an electronic device with the at least one processor 910 capable of executing instructions 930-980, and as such implementations of network device 900 include a mobile device, server, data center, networking device, client device, computer, or other type of electronic device capable of executing instructions 930-980. The instructions 930-980 may be implemented as methods, functions, operations, and other processes implemented as machine-readable instructions stored on the storage medium (or memory) 920, which may be non-transitory, such as hardware storage devices (e.g., random access memory (RAM), read only memory (ROM), erasable programmable ROM, electrically erasable ROM, hard drives, and flash memory).

The at least one processor 910 may fetch, decode, and execute instructions 930-980 to verify SLA compliance of NFCs based on a SFG. Specifically, the at least one processor 910 executes instructions 930-980 to: parse a set of flow rules and network function configurations; identify an equivalent class of packets passing through a network function chain; identify a plurality of paths that packets belonging to the equivalent class pass through; compute a first set of Service Level Agreement (SLA) performance metrics for the equivalent class; construct a set of stateful forwarding criteria comprising the first set of SLA performance metrics; compute a union of the first set of SLA performance metrics for a first flow and a second set of SLA performance metrics for a second flow in response to the first flow and the second flow merge into an aggregated flow; compute an intersection of the first set of SLA performance metrics for a first flow and a second SLA performance metric for a second flow to evaluate impact of an aggregated flow including both the first flow and the second flow on the network device; compute a complement sub-space and performance value corresponding to the first set of SLA performance metrics; compute a difference between sub-spaces and performance values corresponding to the first set of SLA performance metrics for a first flow and a second set of SLA performance metrics for a second flow; use at least the first set of SLA performance metrics to augment a stateful forwarding graph (SFG); determine performance specified in a Service Level Agreement (SLA) for the equivalent class; construct a SLA performance augmented stateful forwarding graph (P-SFG); verify whether the network function chain complies with a SLA based on the stateful forwarding criteria, or SFG, or P-SFG; etc.

The machine-readable storage medium (or memory) 920 includes instructions 930-980 for the processor 910 to fetch, decode, and execute. In another example, the machine-readable storage medium (or memory) 920 may be an electronic, magnetic, optical, memory, storage, flash-drive, or other physical device that contains or stores executable instructions. Thus, the machine-readable storage medium 1020 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium (or memory) 920 may include an application and/or firmware which can be utilized independently and/or in conjunction with the at least one processor 910 to fetch, decode, and/or execute instructions of the machine-readable storage medium (or memory) 920. The application and/or firmware may be stored on the machine-readable storage medium (or memory) 920 and/or stored on another location of the network device 900.

We claim:

1. A method comprising:
parsing, by a network device, a set of flow rules and network function configurations to identify an equivalent class of packets passing through network function chains;
identifying, by the network device, a plurality of paths that packets belonging to the equivalent class pass through;
computing, by the network device, a first set of Service Level Agreement (SLA) performance metrics for the equivalent class;
constructing, by the network device, a set of stateful forwarding criteria comprising the first set of SLA performance metrics; and
verifying, by the network device, whether the network function chains comply with a SLA based on the stateful forwarding criteria.

2. The method of claim 1, wherein the stateful forwarding criteria comprise a plurality of nodes corresponding to the same path, and wherein each node corresponds to a particular performance group on a particular network device.

3. The method of claim 1, wherein the performance group is defined by different values of the first set of SLA performance metrics.

4. The method of claim 1, wherein the first set of SLA performance metrics comprise a hop count, a bandwidth measurement, a link load measurement, a latency measurement.

5. The method of claim 1, wherein the set of flow rules comprises a plurality of intersection rules, union rules, complement rules, and difference rules.

6. The method of claim 1, wherein the equivalent class of packets traverse the same path and belong to the same performance group, and wherein the equivalent class of packets have the same treatment in different network function states.

7. The method of claim 1, further comprising:
computing, by the network device, a union of the first set of SLA performance metrics for a first flow and a second set of SLA performance metrics for a second flow in response to the first flow and the second flow merge into an aggregated flow.

8. The method of claim 1, further comprising:
computing, by the network device, an intersection of the first set of SLA performance metrics for a first flow and a second SLA performance metric for a second flow to evaluate impact of an aggregated flow including both the first flow and the second flow on the network device.

9. The method of claim 1, further comprising:
computing, by the network device, a complement sub-space and performance value corresponding to the first set of SLA performance metrics.

10. The method of claim 1, further comprising:
computing, by the network device, a difference between sub-spaces and performance values corresponding to the first set of SLA performance metrics for a first flow and a second set of SLA performance metrics for a second flow.

11. The method of claim 1, wherein the first set of SLA performance metrics follows a statistic distribution, and wherein the first set of SLA performance metric is further joined with a second set of SLA performance metrics for a second path in the network function chain by computing a convolution of probability density functions associated with two distributions corresponding to the first set of SLA performance metrics and the second set of SLA performance metrics.

12. A system comprising at least a memory and a processor coupled to the memory, the processor executing instructions stored in the memory to:
identify an equivalent class of packets passing through network function chains based on a set of flow rules, wherein the equivalent class of packets traverse the same set of paths and belong to the same performance group;
identify the set of paths that the equivalent class of packets traverse through;
calculate a first set of Service Level Agreement (SLA) performance metrics for the equivalent class;
use at least the first set of SLA performance metrics to augment a stateful forwarding graph (SFG); and
verify whether the network function chains comply with a SLA based on the SFG.

13. The system of claim 12, wherein the SFG comprises a plurality of nodes, each node corresponding to a particular performance group in the same path.

14. The system of claim 13, wherein the particular performance group corresponds to a particular range of values for the first set of SLA performance metrics.

15. The system of claim 11, wherein the first set of SLA performance metrics comprises a hop count, a bandwidth measurement, a link load measurement, and a latency measurement.

16. The system of claim 11, wherein the processor further executes instructions stored in the memory to compute at least one of:
a union of the first SLA performance metric for a first flow and a second SLA performance metric for a second flow in response to the first flow and the second flow merge into a single downstream flow;
an intersection of the first SLA performance metric for a first flow and a second SLA performance metric for a second flow to evaluate impact of both the first flow and the second flow on the network device;
a complement sub-space and performance value corresponding to the first SLA performance metric; and
a difference between sub-spaces and performance values corresponding to the first SLA performance metric for a first flow and a second SLA performance metric for a second flow.

17. The system of claim 11, wherein the first SLA performance metric follows a statistic distribution, and wherein the first SLA performance metric is further joined with a second SLA performance metric for a second path in the network function chain by computing a convolution of probability density functions associated with two distributions corresponding to the first performance metric and the second performance metric.

18. A non-transitory machine-readable storage medium encoded with instructions executable by at least one processor of a network device, the machine-readable storage medium comprising instructions to:
parse a set of flow rules to identify an equivalent class of packets passing through network function chains;
identify a plurality of paths that the equivalent class of packets traverse;
determine performance specified in a Service Level Agreement (SLA) for the equivalent class;
construct a SLA performance augmented stateful forwarding graph (P-SFG); and
verify SLA compliance of the network function chains based on the P-SFG.

19. The non-transitory machine-readable storage medium of claim 18, wherein the network device comprises a software defined network (SDN) controller.

20. The non-transitory machine-readable storage medium of claim 18, wherein the SLA performance metric follows a statistic distribution, and wherein the machine-readable storage medium further comprises instructions to compute a convolution of probability density functions associated with two distributions corresponding to the SLA performance metric and another SLA performance metric corresponding to a different path in the plurality of paths.
